(19) United States
(12) Patent Application Publication
(10) Pub. No.: US 2022/0405374 A1
(43) Pub. Date: Dec. 22, 2022

(54) DECENTRALIZED NETWORK SECURITY

(71) Applicant: Authenticity Institute Inc., Waltham, MA (US)

(72) Inventor: John Wesley Kussmaul, Waltham, MA (US)

(21) Appl. No.: 17/832,550

(22) Filed: Jun. 3, 2022

Related U.S. Application Data
(60) Provisional application No. 63/196,316, filed on Jun. 3, 2021.

(51) Int. Cl. G06F 21/33

(52) U.S. Cl. CPC G06F 21/33; G06F 2221/2141

(57) ABSTRACT

One exemplary embodiment is a method including receiving, at a distributed attestation system, user identification information from a user device. Next, the method includes generating an asymmetric user identifier based on the user identification information. Next, the method includes transmitting the asymmetric user identifier and an attestation identifier to a centralized certificate authority. Next, the method includes receiving a digital certificate generated based on the asymmetric user identifier of the user identification information. Finally, the method includes transmitting the digital certificate to the user device.

### PRIORITY

This patent application claims priority from provisional U.S. patent application No. 63/196,316 filed Jun. 3, 2021, entitled, “DECENTRALIZED NETWORK SECURITY APPARATUS AND METHOD,” and naming John Wesley Kussmaul as inventor, the disclosure of which is incorporated herein, in its entirety, by reference.

### FIELD

Illustrative embodiments generally relate to computer network security and, more particularly, various embodiments of the invention relate to ensuring the identity of an entity, such as a user, on a computer network.

### BACKGROUND

Existing digital identity verification systems suffer from a number of shortcomings and disadvantages. There remain unmet needs including preventing the unauthorized disclosure of user personal information by a centralized system and preventing the duplication or fabrication of digital identities. For instance, a centralized certificate authority maintains the personal information of certificate holders for which the certificate authority issues a digital certificate. The aggregated personal information stored by the certificate authority is a target for cyberattacks. In another example, duplicating or fabricating information to obtain a digital certificate allows a bad actor to defraud or defame a number of people, and then replace the bad actor's damaged reputation by enrolling under a new identity. In view of these and other shortcomings in the art, there is a significant need for the unique apparatuses, methods, systems and techniques disclosed herein.

### DISCLOSURE OF ILLUSTRATIVE EMBODIMENTS

For the purposes of clearly, concisely and exactly describing non-limiting exemplary embodiments of the disclosure, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the present disclosure is thereby created, and that the present disclosure includes and protects such alterations, modifications, and further applications of the exemplary embodiments as would occur to one skilled in the art with the benefit of the present disclosure.

### SUMMARY OF VARIOUS EMBODIMENTS

In accordance with one embodiment of the invention, a method receives, at a distributed attestation system, user identification information from a user device. The method then generates an asymmetric user identifier based on the user identification information. The method then transmits the asymmetric user identifier and an attestation identifier to a centralized certificate authority. The method then receives a digital certificate generated based on the asymmetric user identifier of the user identification information. The method then transmits the digital certificate to the user device.

In some embodiments, the asymmetric user identifier includes a hash. In some embodiments, the user identification information is not transmitted to the centralized certificate authority and the asymmetric user identifier is configured to prohibit the derivation of the user identification information from the asymmetric user identifier. In some embodiments, the method includes storing at least a portion of the user identification information in a database of the distributed attestation system. The digital certificate may include a foundational certificate and the method may include linking, with the distributed attestation system, a secondary certificate to the foundational certificate. The user identification information may include birth certificate data having at least one typographical error.

In another embodiment, a method receives, with a centralized certificate authority, a certificate request including an asymmetric user identifier of user identification information and an attestation identifier. The attestation identifier is configured to identify one attestation device of a distributed attestation system. The method then generates a digital certificate based on the asymmetric user identifier of user identification information and the attestation identifier. The method then transmits the digital certificate to the one attestation device. The user identification information cannot be determined by the centralized certificate authority based on the asymmetric user identifier.

In some embodiments, the method includes receiving, with the centralized certificate authority, a second certificate request including a second asymmetric user identifier of user identification information and a second attestation identifier configured to identify a second attestation device of the distributed attestation system. The method may further include determining the second asymmetric user identifier is identical to the first asymmetric user identifier. The method may further include transmitting a first notification to the first attestation device and a second notification to the second attestation device after determining the second asymmetric user identifier is identical to the first asymmetric user identifier.

In another embodiment, a digital identity verification system includes a centralized certificate authority. The centralized certificate authority is configured to receive a certificate request including an asymmetric user identifier of user identification information and an attestation identifier configured to identify one attestation device of a distributed attestation system. The centralized certificate authority is further configured to generate a digital certificate based on the asymmetric user identifier of user identification information and the attestation identifier. The authority is further configured to transmit the digital certificate to the one attestation device. The user identification information cannot be determined by the centralized certificate authority based on the asymmetric user identifier.

In some embodiments, the system includes the one attestation device configured. The device is configured to receive user identification information from a user device, generate the asymmetric user identifier based on the user identification information, transmit the asymmetric user identifier and an attestation identifier to the centralized certificate authority, receive the digital certificate, and transmit the digital certificate to the user device.

In some embodiments, the system includes the user device configured to transmit the user identification information to the one attestation device. In some embodiments, the digital certificate includes a foundational certificate and the one attestation device is further configured to link a secondary certificate to the foundational certificate.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Detailed Description of Illustrative Embodiments,” discussed with reference to the drawings summarized immediately below.

FIG. 1 is a block diagram illustrating an exemplary digital identify verification system.

FIG. 2 is a block diagram illustrating an exemplary computing device of the digital identify verification system of FIG. 1.

FIG. 3 is a flowchart illustrating an exemplary process for obtaining a digital certificate.

FIG. 4 is a flowchart illustrating an exemplary process for generating a digital certificate and refusing to issue a duplicate certificate.

### DETAILED DESCRIPTION OF ILLUSTRATIVE EMBODIMENTS

In illustrative embodiments, decentralized identity information is used by various services requiring authentication of a user's identity without disseminating the identity information. For example, identify information used to produce a digital certificate by a centralized certificate authority is not transferred to a centralized certificate authority. To that end, user specific data is distributed among a plurality of third parties (e.g., attestation devices corresponding to attestation officers, also known as a notary publics) while a centralized source, such as a certification authority, maintains de-identified information pointing toward the plurality of third parties. At the same time, such embodiments use that de-identified information to authenticate digital certificates and user identities. Details of illustrative embodiments are discussed below.

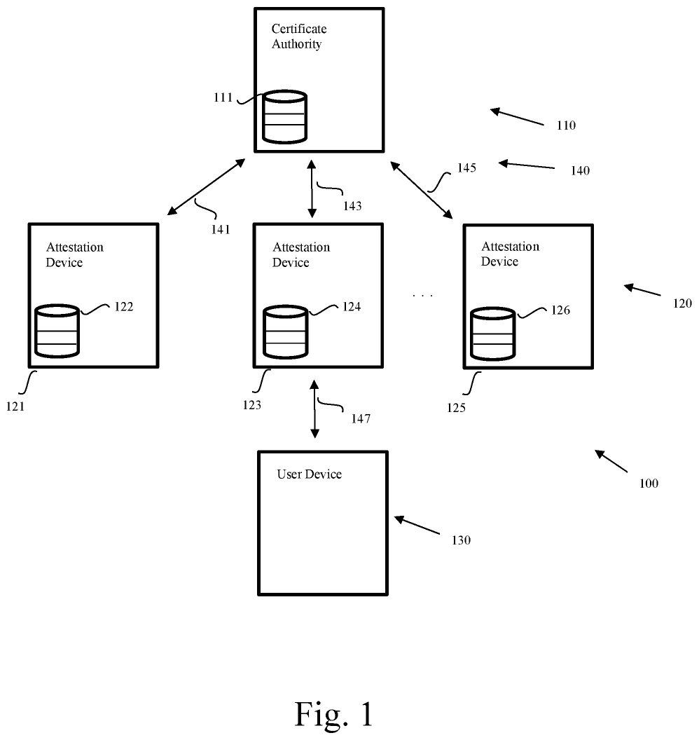

With reference to FIG. 1, there is illustrated a digital identity verification system 100 structured to issue digital certificates to verified users. It shall be appreciated that system 100 may be implemented in a variety of applications, including public key infrastructure, to name but one example. It shall be appreciated that the topology of system 100 is illustrated for the purpose of explanation and is not intended as a limitation of the present disclosure. For example, system 100 may include more or fewer attestation devices, or more user devices, to name but a few examples.

System 100 includes a plurality of communication channels 140 including channels 141, 143, and 145 which connect an attestation device of the distributed attestation system 120 to centralized certificate authority 110. The plurality of communication channels may be wired or wireless connection. For example, the plurality of communications channels may include a wide area network, such as the Internet, or a local area network, to name but a few examples.

System 100 includes a distributed attestation system 120. In the illustrated embodiment, the distributed attestation system 120 includes attestation devices 121, 123, and 125, each of which include a database stored in memory. In certain embodiments, “database” may mean or include a directory, a folder, a file, or other data structure, to name but a few examples.

Each attestation device of system 100 corresponds to an attestation officer. Each attestation officer, and therefore each attestation device, may be physically located in any of a number of different locations. For example, the attestation officers may be located in the same local area network, or even in the same building. Other embodiments, however, physically distribute the attestation officers. For example, the attestation officers may be in different countries and subject to the laws of those different countries. In certain embodiments, an attestation officer is a person. In certain embodiments, an attestation officer is a computer program executable on an attestation device.

Each attestation device of system 100 is structured to receive user identification information from a user device. In the illustrated embodiment, attestation device 123 is receiving user identification information from user device 130. The user identification information is configured to uniquely identify a user. The user identification information may be based on immutable, fixed data. The user identification information may be in a structured format consistent with large populations. For example, the user identification information may include birth certificate data from a government issued birth certificate. The birth certificate data may include the user's given name, the user's family name, the user's mother's name, the user's father's name, address of the user, birthplace of the user (i.e. county, zip code, etc.), or birthdate of the user. System 100 will still generate a digital certificate even though some of the birth certificate data is inaccurate. For instance, if the recorder misspelled names or recorded the wrong birthdate, it may be considered the incorrect information that stays in the birth certificate.

In another example, a user device generates a public key/private key pair, sends the public key to the attestation device, and the certificate request includes the public key of the user while the user retains the private key.

Each attestation device of system 100 may include a database. For example, attestation device 123, which is in communication with user device 130, includes database 124. Database 124 is configured to store at least a portion of the user identification information received from user device 130.

In certain embodiments, the databases of the distributed attestation system 120 form a database (“Heterogeneous DDBMS”) whose contents are distributed among the attestation devices of corresponding attestation officers. In certain embodiments, another database of distributed attestation system 120 may store the user identification information from user device 130 instead of database 124. Neither the user identification information nor a stored portion of the user identification information is shared with centralized certificate authority 110 by the distributed attestation system 120.

Each attestation device is also structured to generate an asymmetric user identifier for a user based on the user identification information provided by the user. The asymmetric user identifier is configured to prohibit the derivation of the user identification information from the asymmetric user identifier.

In certain embodiments, the asymmetric user identifier includes a hash. For example, an attestation device of system 100 may use hashing algorithms and the birth certificate data to produce a unique hash. The hashing algorithm may use the data on the birth certificate, even if it has errors, such as typographical or spelling errors. Indeed, other embodiments may use other conversion processes and/or other identifying information and thus, discussion of a hashing algorithm and birth certificate data are for illustrative purposes only.

Some embodiments may further enhance security by having multiple layers of hashes. For example, the attestation officer may have another attestation officer store the user identification information on their corresponding attestation device. Moreover, some embodiments may use backup attestation devices to maintain duplicate user identification information. This embodiment may be helpful when a primary attestation officer is no longer able to serve their function.

In some embodiments, five or fewer pieces of birth certificate data shall be placed in a JSON and formatted with JSON.parse and JSON.stringify(str,null,2) before creating the digital signature. Therefore, the illustrated birth certificate data shown here:

{
“payload”: {
“innovation”: {
“givenName”: “Jane”,
“surname”: “Doe”,
“birthMonthDay”: “Jan 17”,
“postalCode”: “85032”,
}
},

will be used to generate an asymmetric user identifier shown below.

“signature”: {
“signaturevalue”:
“jz4bEW2FBMDkANyEjiPnrIctucHQCIwxrtzBXt+rVGmYME
flHrOwf7FYLH60E3Oz54VwSSQCi9J4tXQIhv4SofT5opbcIUj
7ji6QrC6c+a3YLjg81/+/
uFjhzsLelAO4gh2k0FJxM041jH0GZGuXTzhRnqTzJTnYSVo7
2PC92NA=”
}

Upon generating the asymmetric user identifier, attestation device 123 may generate a certificate request, also known as a certificate signing request, including the symmetric user identifier and an attestation identifier configured to identify the attestation officer and corresponding attestation device from which the certificate request is transmitted. In certain embodiments, the attestation identifier is a digital signature of the attestation officer. The certificate request does not include the user identification information. Upon generating the certificate request, attestation device 123 transmits the certificate request to centralized certificate authority 110. It shall be appreciated that the attestation devices of system 100, and not the centralized certificate authority, are configured to map between the asymmetric user identifier and the identity of the user in a tamper-evident journal (i.e. database) of enrollments which they performed. In certain embodiments, distributed attestation system 120 may also, at the request of the enrolled user, provide other services, such as information backup services and credential escrow. Distributed attestation system 120 may, for example, link secondary certificates, also known as utility certificates, to the digital certificate received from the centralized certificate authority, also known as a foundational certificate, allowing one verified user to have multiple personas for tasks such as authentication, sign in, and encryption key management. In this way, only the attestation

System 100 includes a centralized certificate authority 110 structured to communicate with a distributed attestation system 120. Centralized certificate authority 110 is structured to store an asymmetric user identifier and corresponding attestation identifier from each certificate request in a database. In this way, centralized certificate authority 110 does not receive or retain user identification information. Centralized certificate authority 110 is also structured to receive third party certificate validation requests and validate the certificate in question if the certificate is indeed valid.

In response to a certificate request from an attestation device of distributed attestation system 120, authority 110 is structured verify the attestation identifier, and to generate a digital certificate and maintain the digital certificate, so long as the certificate request does not include a duplicate asymmetric user identifier. In certain embodiments, the digital certificate is an X.509 certificate. In certain embodiments, generating a digital certificate means or includes signing an existing certificate included in the certificate request, the existing certificate incorporating the asymmetric user identifier and the attestation identifier. When centralized certificate authority 110 receives a new certificate request including a new asymmetric user identifier, centralized certificate authority 110 compares the new asymmetric user identifier to the stored asymmetric user identifier. If centralized certificate authority 110 determines the new asymmetric user identifier is identical to a stored asymmetric user identifier, centralized certificate authority 110 does not generate a new digital certificate. Instead, centralized certificate authority 110 may use the attestation identifiers to notify the attestation devices which sent the stored asymmetric user identifier and the new asymmetric user identifier of the duplicative certificate request.

In certain embodiments, a user enrolls in the certificate issuance process by submitting a request to centralized certificate authority 110, a third party system, or one of the attestation devices of distributed attestation system 120. When the user submits the request to centralized certificate authority 110 or a third party system, centralized certificate authority 110 or the third party system may assign one of the attestation officers corresponding to one of the attestation devices of system 100 to verify the identity of the user.

User device 130 corresponding to a user that wants to produce a digital certificate to confirm that user's identity. The user device may store a complete set of user identification information in a well-protected data structure. User device 130 may also include a display configured to receive a request to enroll in the certificate issuance process from the user.

System 100 is configured to produce a digital certificate, also known as digitally signed credential, that the user can present to assert the user's identity online. In response to the assertion, a relying party may use the digital certificate, through its own authorization facilities, such as access to an online facility via an access control list (ACL), a list of certificate serial numbers, or public keys that grant access. Such embodiments affirm that a given certificate represents a real, properly enrolled human being, and provides the certification authority that can back up that claim.

For the purposes of illustration, the following is a scenario where system 100 may be used to prevent duplicate digital certificates from being issued. When an individual enrolls to a Digital Birth Certificate credential, the structured information of the birth certificate is hashed and sent to the City of Osmio Vital Records Department hash table. A subset of birth certificate data from the identify verification is kept in a tamper-evident journal on an attestation device by the attestation officer who enrolled the subject to a Digital Birth Certificate identity credential.

A record of that hash and which licensed attestation officer completed the Digital Birth Certificate procedure for any certificate issued by the Certification Authority of the City of Osmio will be maintained in the central database at the City of Osmio Vital Records Department on servers in Geneva. The City of Osmio Vital Records Department central database has only a hashed version of the five elements of the original birth certificate.

If there is an exact match in the table, then that match indicates a possible duplicate enrollment. In that case the attestation officers who created the identical hashes are contacted, and the two attestation officers compare the five items of birth certificate data to determine whether a duplicate enrollment has in fact taken place. At no time in this process is birth certificate data, or other user identification information, disclosed to any central authority.

It shall be appreciated that any or all of the foregoing features of system 100 may also be present in the other embodiments disclosed herein.

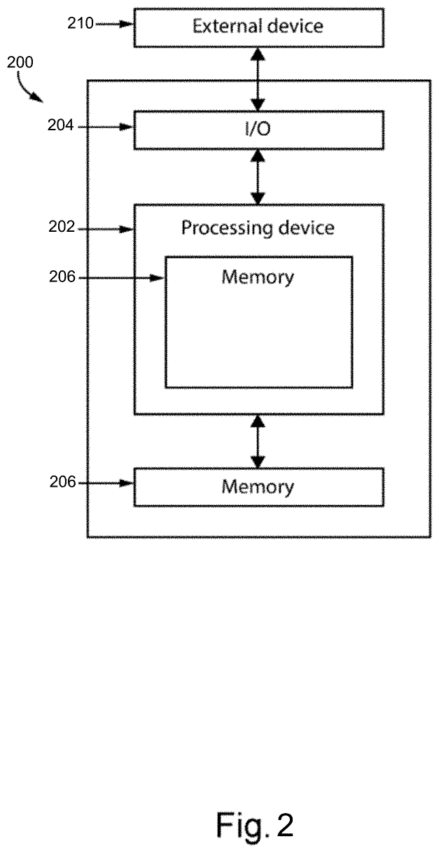

With reference to FIG. 2, there is illustrated a schematic block diagram of a computing device 200. Computing device 200 is one example of a computing device which is used, in different embodiments, in connection with an exemplary digital signature verification system, such as certificate authority 110, the attestation devices 121, 123, and 125, or user device 130 shown in FIG. 1. Computing device 200 includes a processing device 202, an input/output device 204, and a memory device 206. Computing device 200 may be a stand-alone device, an embedded system, or a plurality of devices structured to perform the functions described with respect to system 100. Furthermore, computing device 200 communicates with one or more external devices 210.

Input/output device 204 enables the computing device 200 to communicate with an external device 210. For example, input/output device 204 in different embodiments may be a network adapter, network credential, interface, or a port (e.g., a USB port, serial port, parallel port, an analog port, a digital port, VGA, DVI, HDMI, FireWire, CAT 5, Ethernet, fiber, or any other type of port or interface), to name but a few examples. Input/output device 204 is comprised of hardware, software, and/or firmware. It is contemplated that input/output device 204 includes more than one of these adapters, credentials, or ports, such as a first port for receiving data and a second port for transmitting data.

External device 210, is any type of device that allows data to be input or output from computing device 200. For example, external device 210 may include a sensor, a mobile device, a reader device, equipment, a handheld computer, a diagnostic tool, a controller, a computer, a server, a printer, a display, a visual indicator, a keyboard, a mouse, or a touch screen display. Furthermore, it is contemplated that external device 210 is integrated into computing device 200. It is further contemplated that more than one external device is in communication with computing device 200.

Processing device 202 in different embodiments is a programmable type, a dedicated, hardwired state machine, or a combination of these. Device 202 can further include multiple processors, Arithmetic-Logic Units (ALUs), Central Processing Units (CPUs), Digital Signal Processors (DSPs), Field-programmable Gate Array (FPGA), to name but a few examples. For forms of processing device 202 with multiple processing units, distributed, pipelined, or parallel processing can be used as appropriate. Processing device 202 may be dedicated to performance of just the operations described herein or may be utilized in one or more additional applications. In the illustrated form, processing device 202 is of a programmable variety that executes processes and processes data in accordance with programming instructions (such as software or firmware) stored in memory device 206. Alternatively or additionally, programming instructions are at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory device 206 in different embodiments is of one or more types, such as a solid-state variety, electromagnetic variety, optical variety, or a combination of these forms, to name but a few examples. Furthermore, memory device 206 can be volatile, nonvolatile, transitory, non-transitory or a combination of these types, and some or all of memory device 206 can be of a portable variety, such as a disk, tape, memory stick, or cartridge, to name but a few examples. In addition, memory device 206 can store data that is manipulated by processing device 202, such as data representative of signals received from or sent to input/output device 204 in addition to or in lieu of storing programming instructions, just to name one example. As shown in FIG. 2, memory device 206 may be included with processing device 202 or coupled to processing device 202, but need not be included with both. It shall be appreciated that any or all of the foregoing features of computing device 200 may also be present in the features and components of the digital identity verification systems disclosed herein.

The processes in the present application may be implemented with programming instructions as operations by software, hardware, artificial intelligence, fuzzy logic, or any combination thereof, or at least partially performed by a user or operator. In certain embodiments, units represent software elements as a computer program encoded on a non-transitory computer readable medium performing the described operations when executing the computer program.

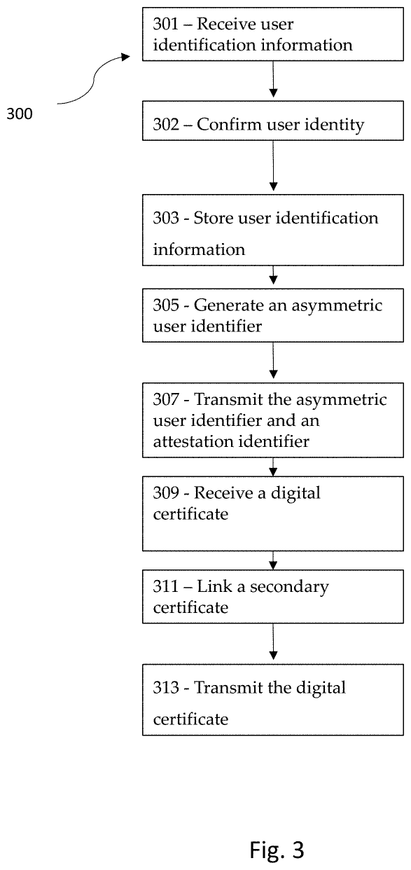

With reference to FIG. 3, there is illustrated an exemplary process 300 for operating an attestation device to obtain a digital certificate from a certificate authority. Process 300 may be implemented in whole or in part in one or more of the attestation devices disclosed herein. In certain forms process 300 may be performed by the same attestation device. It shall be further appreciated that a number of variations and modifications to process 300 are contemplated including, for example, the omission of one or more aspects of process 300, the addition of further conditionals and operations and/or the reorganization or separation of operations and conditionals into separate processes.

Process 300 begins at operation 301 where an attestation device of a distributed attestation system including a plurality of attestation devices receives user identification information from a user device.

Process 300 proceeds to operation 302 where the attestation device confirms the identity of a user using the user identification information.

Process 300 proceeds to operation 303 where the attestation device stores at least a portion of the user identification information in a database of the distributed attestation system. In certain embodiments, process 300 does not include operation 303.

Process 300 proceeds to operation 305 where the attestation device generates an asymmetric user identifier based on the user identification information.

Process 300 proceeds to operation 307 where the attestation device transmits the asymmetric user identifier and an attestation identifier to a centralized certificate authority. In certain embodiments, the attestation device communicates with the centralized certificate authority by way of an intermediate party.

Process 300 proceeds to operation 309 where the attestation device receives a digital certificate from the centralized certificate authority. The digital certificate is generated based on the asymmetric user identifier of the user identification information.

Process 300 proceeds to operation 311 where the attestation device links a secondary certificate to the digital certificate, also known as a foundational certificate.

Process 300 proceeds to operation 313 where the attestation device transmits the digital certificate to the user device. In certain embodiments, the attestation devices also transmits one or more linked secondary certificates with the digital certificate.

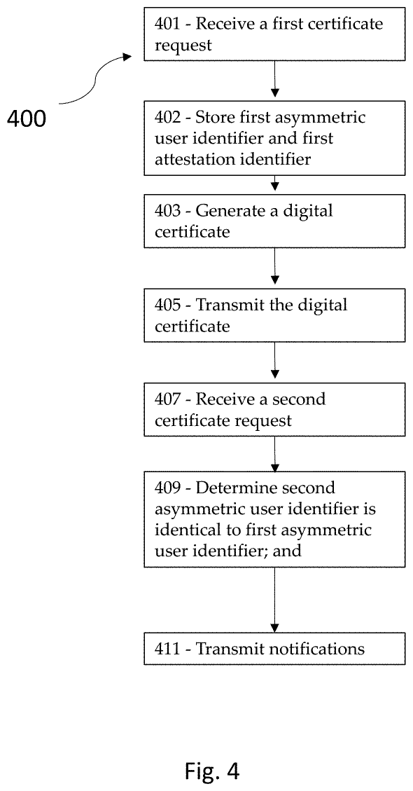

With reference to FIG. 4, there is illustrated an exemplary process 400 for generating a digital certificate and refusing to issue a duplicate certificate with a centralized certificate authority. Process 400 may be implemented in whole or in part in one or more of centralized certificate authorities disclosed herein. It shall be further appreciated that a number of variations and modifications to process 400 are contemplated including, for example, the omission of one or more aspects of process 400, the addition of further conditionals and operations and/or the reorganization or separation of operations and conditionals into separate processes.

Process 400 begins at operation 401 where a centralized certificate authority receives a certificate request from an attestation device. The certificate request includes an asymmetric user identifier of user identification information and an attestation identifier. The attestation identifier may be configured to identify the attestation device. The user identification information cannot be determined by the centralized certificate authority based on the asymmetric user identifier.

Process 400 proceeds to operation 402 where the centralized certificate authority stores the asymmetric user identifier and attestation identifier.

Process 400 proceeds to operation 403 where the centralized certificate authority generates a digital certificate based on the asymmetric user identifier of user identification information and the attestation identifier.

Process 400 proceeds to operation 405 wherein the centralized certificate authority transmits the digital certificate to the attestation device.

In the illustrated embodiment, process 400 proceeds to operation 407 where the centralized certificate authority receives a second certificate request from another attestation device of the distributed attestation system. The second certificate request includes a second asymmetric user identifier of user identification information for a different user and a second attestation identifier configured to identify the second attestation device. In other embodiments, process 400 does not include operations 407-411.

Process 400 proceeds to operation 409 where the centralized certificate authority determines the second asymmetric user identifier is identical to the first asymmetric user identifier.

Process 400 proceeds to operation 411 wherein the centralized certificate authority transmits a first notification to the first attestation device and a second notification to the second attestation device after determining the second asymmetric user identifier is identical to the first asymmetric user identifier.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” and/or “a portion” is used, the item can include a portion and/or the entire item unless specifically stated to the contrary.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended innovations.

What is claimed is:

1. A method, comprising:
receiving, at a distributed attestation system, user identification information from a user device;
generating an asymmetric user identifier based on the user identification information;
transmitting the asymmetric user identifier and an attestation identifier to a centralized certificate authority;
receiving a digital certificate generated based on the asymmetric user identifier of the user identification information; and
transmitting the digital certificate to the user device.

2. The method of claim 1, wherein the asymmetric user identifier includes a hash.

3. The method of claim 1, wherein the user identification information is not transmitted to the centralized certificate authority; and wherein the asymmetric user identifier is configured to prohibit the derivation of the user identification information from the asymmetric user identifier.

4. The method of claim 1, comprising:
storing at least a portion of the user identification information in a database of the distributed attestation system.

5. The method of claim 4, wherein the digital certificate includes a foundational certificate and the method further comprises linking, with the distributed attestation system, a secondary certificate to the foundational certificate.

6. The method of claim 1, wherein the user identification information includes birth certificate data having at least one typographical error.

7. The method of claim 1, further comprising:
receiving, with the centralized certificate authority, a certificate request including the asymmetric user identifier and the attestation identifier;
generating the digital certificate based on the asymmetric user identifier; and
transmitting the digital certificate to an attestation device of the distributed attestation system corresponding to the attestation identifier,
wherein the user identification information cannot be determined based on the asymmetric user identifier.

8. A method, comprising:
receiving, with a centralized certificate authority, a certificate request including an asymmetric user identifier of user identification information and an attestation identifier configured to identify one attestation device of a distributed attestation system;
generating a digital certificate based on the asymmetric user identifier of user identification information and the attestation identifier; and
transmitting the digital certificate to the one attestation device,
wherein the user identification information cannot be determined by the centralized certificate authority based on the asymmetric user identifier.

9. The method of claim 8, comprising:
receiving, with the centralized certificate authority, a second certificate request including a second asymmetric user identifier of user identification information and a second attestation identifier configured to identify a second attestation device of the distributed attestation system;
determining the second asymmetric user identifier is identical to the first asymmetric user identifier; and
transmitting a first notification to the first attestation device and a second notification to the second attestation device after determining the second asymmetric user identifier is identical to the first asymmetric user identifier.

10. The method of claim 8, wherein the asymmetric user identifier includes a hash.

11. The method of claim 8, wherein the user identification information is not transmitted to the centralized certificate authority; and wherein the asymmetric user identifier is configured to prohibit the derivation of the user identification information from the asymmetric user identifier.

12. The method of claim 8, wherein the digital certificate includes a foundational certificate and the method further comprises linking, with the distributed attestation system, a secondary certificate to the foundational certificate.

13. The method of claim 8, wherein the user identification information includes birth certificate data.

14. A digital identity verification system, comprising:
a centralized certificate authority configured to:
receive a certificate request including an asymmetric user identifier of user identification information and an attestation identifier configured to identify one attestation device of a distributed attestation system,
generate a digital certificate based on the asymmetric user identifier of user identification information and the attestation identifier, and
transmit the digital certificate to the one attestation device,
wherein the user identification information cannot be determined by the centralized certificate authority based on the asymmetric user identifier.

15. The digital identity verification system of claim 14, comprising:
the one attestation device configured to:
receive user identification information from a user device,
generate the asymmetric user identifier based on the user identification information,
transmit the asymmetric user identifier and an attestation identifier to the centralized certificate authority,
receive the digital certificate, and
transmit the digital certificate to the user device.

16. The digital identity verification system of claim 15, comprising:
the user device configured to transmit the user identification information to the one attestation device.

17. The digital identity verification system of claim 15, wherein the digital certificate includes a foundational certificate and the one attestation device is further configured to link a secondary certificate to the foundational certificate.

18. The digital identity verification system of claim 14, wherein the asymmetric user identifier includes a hash.

19. The digital identity verification system of claim 14, wherein the user identification information is not transmitted to the centralized certificate authority; and wherein the asymmetric user identifier is configured to prohibit the derivation of the user identification information from the asymmetric user identifier.

20. The digital identity verification system of claim 14, wherein the user identification information includes birth certificate data having at least one typographical error.

21. A computer program product for use on a computer system obtaining a digital certificate, the computer program product comprising a tangible, non-transient computer usable medium having computer readable program code thereon, the computer readable program code comprising:
program code for receiving, with a centralized certificate authority, a certificate request including an asymmetric user identifier of user identification information and an attestation identifier configured to identify one attestation device of a distributed attestation system;
program code for generating the digital certificate based on the asymmetric user identifier of user identification information and the attestation identifier; and
program code for transmitting the digital certificate to the one attestation device,
wherein the user identification information cannot be determined by the centralized certificate authority based on the asymmetric user identifier.

22. The computer program product of claim 21, wherein the computer readable program code comprises:
program code for receiving, with the centralized certificate authority, a second certificate request including a second asymmetric user identifier of user identification information and a second attestation identifier configured to identify a second attestation device of the distributed attestation system;
program code for determining the second asymmetric user identifier is identical to the first asymmetric user identifier; and
program code for transmitting a first notification to the first attestation device and a second notification to the second attestation device after determining the second asymmetric user identifier is identical to the first asymmetric user identifier.

23. The computer program product of claim 21, wherein the computer readable program code comprises:
program code for receiving, at the distributed attestation system, the user identification information from a user device;
program code for generating the asymmetric user identifier based on the user identification information;
program code for transmitting the asymmetric user identifier and an attestation identifier to the centralized certificate authority;
program code for receiving the digital certificate at the one attestation device; and
program code for transmitting the digital certificate to the user device.
